(19) United States
(12) Patent Application Publication
(10) Pub. No.: US 2009/0025495 A1
(43) Pub. Date: Jan. 29, 2009

(54) Davison-drive

(76) Inventor: Donald Eric Davison, Livonia, MI (US)

Correspondence Address: DONALD ERIC DAVISON, 19961 BRENTWOOD STREET, LIVONIA, MI, 48152, US

(21) Appl. No.: 11/881,081

(22) Filed: Jul. 25, 2007

(51) Int. Cl. F03G 7/00

(52) U.S. Cl. 74/1 R

(57) ABSTRACT

My invention will allow mankind the use of a power plant in the science of space travel including the use of a small hand powered unit a person can use to get around when outside the space vehicle.

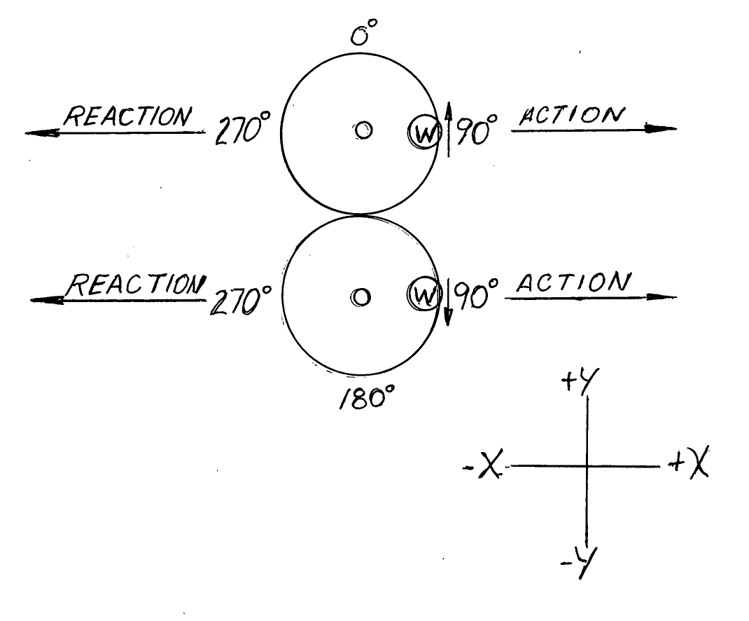

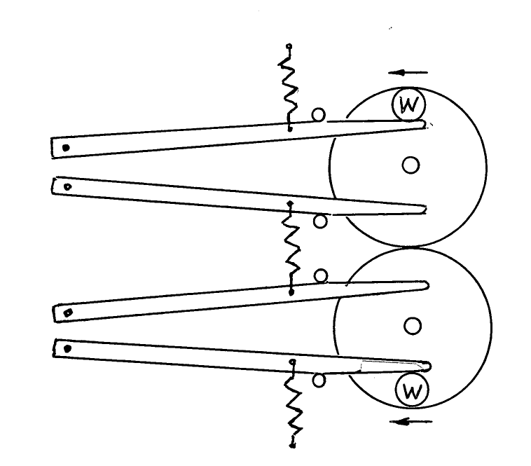

While my invention is going to be a boon to space travel, that will not be its only possible use. Highway vehicles and boats can also be pushed by these devices, the popularity of these uses will depend on the device's power per pound and miles per gallon results.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

There is a law of physics that states: For every action there is an equal and opposite reaction. The absolute obedience to this law has prevented space science from developing a means of pushing space vehicles without using some rocket type action, that is, until now. I have discovered a process in which a mechanical device will yield action with reduced reaction. The net result is action without the required reaction.

### BRIEF SUMMARY OF THE INVENTION

The process is to build some device that causes reaction to lag behind action. Then after each movement of action and before each reaction should take place, we remove the energy from whatever parts of the device that would make the reaction. This results in the reaction being much less than the action.

### BRIEF DESCRIPTION OF THE SEVERAL VIEWS OF THE DRAWINGS

Drawing 1/2 shows the part of my invention that will perform the act of making reaction lag action. The two wheels are synchronized together by some means like gears. The wheels have the same size weights fasten to their rims. When we rotate the wheels, there will be a force to the right as the weights pass the 90 degree point of their rotation, likewise, when the weights pass the 270 degree point there is an equal and opposite force to the left. All the Y-Y components of forces cancel each other out.

When we mount the assembly on rollers there will be a movement of an action to the right followed by an equal and opposite movement of reaction to the left. While there is no gain in movement yet, the importance of this part of the invention is that reaction has been made to lag 180 degrees behind action. This lag is the key to the invention because it gives us enough time to remove all the energy from the weights before they create a full reaction.

Drawing 2/2, my selection to be the cover sheet, shows the addition of one means to remove the energy from the moving weights. In this drawing the moving weights engage levers that have springs attached to them. The energy of the moving weights is transferred to the springs, bringing the weights to a halt. The springs now return the energy to the weights and rotate them again, but now in the reverse direction.

### DETAILED DESCRIPTION OF THE INVENTION

A device is built that has one or more pairs of rotating equal weights. When the two weights of a pair move, they move in opposite directions. Both weights move in the same plain or in parallel plains. The weights are synchronized so that both weights will cross the 90 degree point at the same time, but in opposite directions. When the weights do pass the 90 degree point, they produce a forward force in the plus X direction, but when they approach the 270 degree point the weights engage levers. The springs that are attached to the levers are strong enough to bring the weights to a halt before the 270 degree position. Halting the weights removes all the energy from the weights and renders them unable to produce a full reaction.

The difference between action and reaction can be seen by testing the device by hand. In the case of my working breadboard model, I placed rollers under the model so that it would be free to move forward or backwards. I then moved the weights so that they engaged the levers and pulled on the springs. I carefully let go of the weights and watched the movement of the model. When the weights crossed the 90 degree position the model moved forward about six inches, but the model only moved less than one half of an inch backwards when the weights were halted near the 270 degree position. Reaction has been reduced by as much as ninety percent in these tests. The weights then reversed their rotation and created another forward movement at 90 degrees. This testing proves that the model produced action with less reaction. The net result is action without the required reaction.

1. I claim the process of causing reaction to lag behind action for a period of time in which the energy is taken out of whatever would make the reaction.

2. I claim any device that has two or more rotating weighs and a means of removing energy from the weights after the action and before the reaction.
